(19) United States
(12) Patent Application Publication
(10) Pub. No.: US 2011/0251776 A1
(43) Pub. Date: Oct. 13, 2011

(54) FUEL ACCUMULATOR AND FUEL SYSTEM USING THE SAME

(75) Inventors: Peter E. Bartell, Ontario, NY (US); Lucille G. Lavan, Pittsford, NY (US); David Howard Burke, Victor, NY (US)

(73) Assignee: DELPHI TECHNOLOGIES, INC., Troy, MI (US)

(21) Appl. No.: 12/756,592

(22) Filed: Apr. 8, 2010

(51) Int. Cl. F02D 41/30; F02M 69/46; F02M 63/00

(52) U.S. Cl. 701/103; 123/447; 123/456

(57) ABSTRACT

A fuel accumulator is provided to assist restarting a direct injection engine fuel system. The fuel accumulator includes a central guide post with a fuel passage. A cup shaped plunger with a closed end is slideably disposed on the central guide post. A seal means is disposed between the plunger and the central guide post to define a substantially sealed fuel chamber. A biasing means is provided to urge the plunger onto the central guide post. A fuel admission valve selectively prevents and permits fuel from entering and exiting the fuel accumulator. When a fuel system stop is commanded, pressurized fuel is admitted into the fuel chamber, thereby compressing the biasing means which maintains a restart pressure. When a fuel system start is commanded, pressurized fuel is expelled from the fuel accumulator.

### TECHNICAL FIELD OF INVENTION

The present invention relates to a fuel accumulator; and more particularly to a fuel rail including such a fuel accumulator; and most particularly to a fuel system using such a fuel accumulator.

### BACKGROUND OF INVENTION

As an effort to conserve fuel, the automotive industry has proposed turning off the internal combustion engine of a motor vehicle rather than allowing the internal combustion engine to idle when the motor vehicle comes to a stop, for example, when the motor vehicle is stopped at a traffic light. This technique has been implemented in hybrid vehicles which use an electric motor to resume motion of the motor vehicle while the internal combustion engine is being restarted. By using the electric motor, motion of the motor vehicle can resume without waiting for the starter of the internal combustion engine to perform the restart. The technique of turning off the internal combustion engine when the motor vehicle comes to a stop is also desirable for non-hybrid motor vehicles that use only an internal combustion engine for propulsion. In order to avoid the delay of waiting for the starter of the internal combustion engine to perform the restart, one proposal has been made which would use fuel and spark to instantly produce driving power. For this technique to work, high pressure fuel would need to be instantly available upon a command to restart the engine.

One system proposed to provide high pressure fuel to the internal combustion engine is shown in U.S. Pat. No. 6,234,128. In this configuration, a piston-type fluid accumulator is provided in a fuel system for an internal combustion engine. When the internal combustion engine is running, high pressure fuel is supplied to an accumulator chamber. A piston is moved in the accumulator chamber by the high pressure fuel in order to compress a spring. The piston includes a catch member which latches with a latch member when the piston has compressed the spring. In this way, the piston is held in place when the internal combustion engine has been stopped and is ready to be placed under load of the spring when the latch member is released. Since the accumulator chamber is in constant fluid communication with the fuel system, the pressure within the accumulator chamber will drop as the pressure in the fuel system drops when the internal combustion engine is not running. Therefore, the fuel in the accumulator may not always be maintained at a pressure necessary for restarting the internal combustion engine. If fuel vapor has formed in the fuel system when the internal combustion engine is to be restarted, there will not be sufficient time for the spring to recompress the vapor to start the engine in a satisfactory length of time when the latch member releases the piston.

What is needed is a piston-type fuel accumulator that maintains a volume of fuel at a pressure necessary for restarting an internal combustion engine. What is further needed is a fuel rail including such a fluid accumulator. What is also further needed is a fuel system using such a fluid accumulator.

### SUMMARY OF THE INVENTION

Briefly described, the present invention provides a fuel accumulator for use in a direct injection engine fuel system with a fuel rail and a fuel system controller that starts and stops the direct injection engine fuel system on command. The direct injection engine fuel system has a predetermined pressure required to restart the system. The fuel accumulator includes a central guide post having a fuel passage therethrough; a cup shaped, closed ended plunger is slidably disposed on the central guide post. A seal means is operable between the plunger and the central guide post to create a substantially sealed fuel chamber within the plunger. A biasing means is provided in order to urge the plunger onto the central guide to pressurize the fuel chamber. A fuel admission valve is located between the central guide post and fuel rail to selectively provide fluid communication between the fuel passage and the fuel rail in response to the fuel system controller. When the fuel system controller commands a system stop, the fuel admission valve is opened to admit pressurized fuel into the fuel chamber, thereby compressing the biasing means until the fuel pressure within the fuel chamber rises to at least the restart pressure. The fuel admission valve is then closed and the biasing means maintains the restart pressure in the fuel chamber. When the fuel system controller commands a system start, the fuel admission valve is opened to admit pressurized fuel into the fuel rail from the fuel chamber.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a schematic of a direct injection fuel system including a fuel accumulator in accordance with the present invention;

FIG. 2 is a cross section of a fuel accumulator in a discharged state in accordance with the present invention; and

FIG. 3 is a cross section of a fuel accumulator in a charged state in accordance with the present invention.

### DETAILED DESCRIPTION OF INVENTION

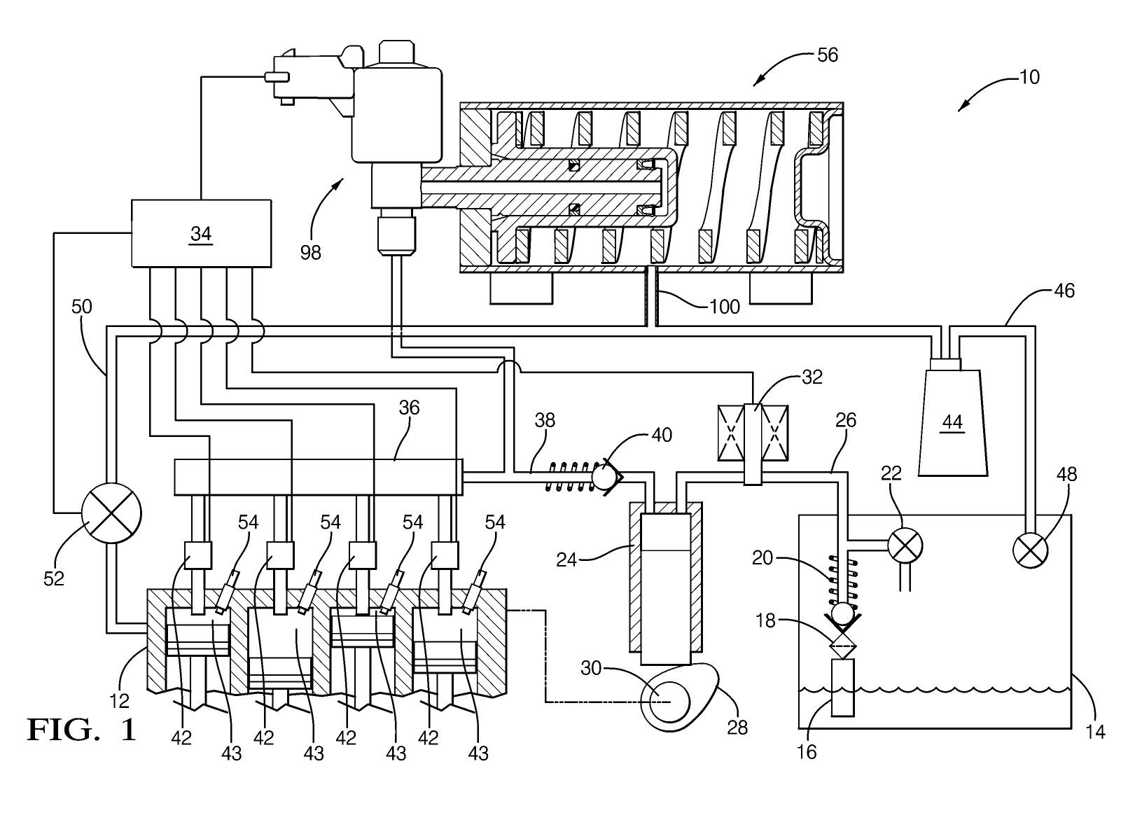

In accordance with a preferred embodiment of this invention and referring to FIG. 1, direct injection engine fuel system 10 is shown for providing liquid fuel to internal combustion engine 12. Direct injection engine fuel system 10 includes fuel tank 14 for storing liquid fuel which is used to fuel internal combustion engine 12. The liquid fuel stored in fuel tank 14 may be gasoline, ethanol, a blend of gasoline and ethanol, diesel fuel, or any other liquid fuel that may be used to fuel internal combustion engine 12. Low pressure fuel pump 16 is disposed inside fuel tank 14 in order to convey liquid fuel out of fuel tank 14. Low pressure fuel pump 16 is typically capable of supplying liquid fuel at a pressure in the range of 400 kPa to 600 kPa with a typical desired pressure being 500 kPa. Fuel filter 18 may also be disposed inside fuel tank 14 on the output side of low pressure fuel pump 16 in order to filter contaminants out of the liquid fuel before the liquid fuel is conveyed to other components in the direct injection engine fuel system 10. Check valve 20 may also be disposed inside fuel tank 14 on the output side of low pressure fuel pump 16 and downstream of fuel filter 18 in order to prevent backflow of fuel into low pressure fuel pump 16. Pressure regulator 22 may also be disposed inside fuel tank 14 on the output side of low pressure fuel pump 16 and downstream of check valve 20 in order to regulate the pressure of the liquid fuel that is being conveyed out of fuel tank 14 to a predetermined pressure. Pressure regulator 22 typically regulates fuel to a pressure in the range of 400 kPa to 600 KPa with a typical desired pressure being 500 kPA. Pressure regulator 22 will open in proportion to the fuel pressure in low pressure fuel line 26 allowing excess liquid fuel back to fuel tank 14, thereby maintaining the pressure of the liquid fuel exiting check valve 20 close to the predetermined value. While low pressure fuel pump 16, fuel filter 18, check valve 20, and pressure regulator have been described and shown as being disposed inside fuel tank 14 in a particular order, one of ordinary skill in the art of direct injection engine fuel systems will now recognize that one or more of these elements may be disposed outside of fuel tank 14 and may similarly be placed in a different order.

Liquid fuel is conveyed out of fuel tank 14 by low pressure fuel pump 16 to high pressure fuel pump 24 through low pressure fuel line 26. High pressure fuel pump 24 may be a piston type pump that is driven by cam lobe 28 of camshaft 30 of internal combustion engine 12. In a piston type pump, piston 31 is reciprocated in a cylinder bore 33. The stroke of piston 31 in cylinder bore 31 pressurizes the liquid fuel. High pressure fuel pumps are typically capable of supplying liquid fuel at a pressure in the range of 3 MPa to 26 Mpa with typical desired pressures being between 5 MPa and 20 MPa which is determined by fuel system controller 34 based on fuel pressure needs of internal combustion engine 12. Control valve 32 is disposed in low pressure fuel line 26 to selectively permit and prevent fluid communication between low pressure fuel line 26 and high pressure fuel pump 24. Control valve 32 may be controlled by fuel system controller 34 to allow low pressure liquid fuel to be admitted to high pressure fuel pump 24 from low pressure fuel line 26 after high pressure fuel pump 24 has discharged a high pressure charge of liquid fuel to internal combustion engine 12. Likewise, control valve 32 may also be controlled by fuel system controller 34 to prevent fluid communication between low pressure fuel line 26 and high pressure fuel pump 24 after a low pressure charge of liquid fuel has been supplied to high pressure fuel pump 24 and is ready to be pressurized to high pressure by high pressure fuel pump 24.

Control valve 32 and fuel system controller 34 also control the pressure of liquid fuel output by high pressure fuel pump 24 by limiting the quantity of liquid fuel admitted into high pressure fuel line 38 from high pressure fuel pump 24. In order to do this, fuel system controller 34 determines the amount of liquid fuel that will be required by internal combustion engine 12 and also determines what portion of the stroke of high pressure fuel pump 24 is needed to meet the fuel requirement. Control valve 32 is commanded open by fuel system controller 34 when the determined portion of the stroke of high pressure fuel pump 24 has been completed, thus allowing the remainder of the high pressure charge to be supplied back to into low pressure fuel line 26. High pressure fuel pumps and piston type pumps are well known to those skilled in the art of direct injection engine fuel systems and will not be discussed further herein.

Liquid fuel is conveyed to fuel rail 36 from high pressure fuel pump 24 through high pressure fuel line 38. High pressure check valve 40 may be disposed in high pressure fuel line 38 to prevent backflow of liquid fuel into high pressure fuel pump 24. One or more fuel injectors 42 are fluidly connected to fuel rail 36 in know fashion for receiving liquid fuel therefrom and for injecting liquid fuel into one or more corresponding combustion chambers 43 of internal combustion engine 12.

Direct injection engine fuel system 10 may also include evaporative emissions canister 44. Evaporative emissions canister 44 is fluidly connected to fuel tank 14 by fuel tank vapor line 46 in order to convey fuel vapors present in fuel tank 14 to evaporative emissions canister 44. Roll-over valve 48 may be disposed inside fuel tank 14 and fluidly between fuel tank vapor line 46 and fuel tank 14. When evaporative gas is formed in fuel tank 14 such that a predetermined vapor pressure is reached, roll-over valve 48 will open to allow fuel vapor to be conveyed to evaporative emissions canister 44. Roll-over valve 48 may also be configured to prevent liquid fuel from being expelled from fuel tank 14 in the event fuel tank 14 is tilted excessively or overturned as may occur in a motor vehicle accident. Evaporative emissions canister 44 is also fluidly connected to internal combustion engine 12 by purge line 50. Purge valve 52 may be disposed in purge line 50 for selectively preventing and permitting fluid communication of evaporative emissions canister 44 with internal combustion engine 12. When purge valve 52 is opened by command of fuel system controller 34 during operation of internal combustion engine 12, vacuum generated by internal combustion engine 12 is used to convey gas vapors from the evaporative emissions canister 44 to internal combustion engine 12 where the gas vapors can be consumed in combustion chambers 43 along with the liquid fuel that has been provided as described earlier. The operation of an evaporative emissions canister in a direct injection fuel system is well known to those skilled in the art of direct injection fuel systems and will not be discussed further herein.

Internal combustion engine 12 may be configured to start on command by using spark plugs 54 to ignite liquid fuel that has been injected into combustion chambers 43 at high pressure rather than using a conventional starter (not show) to begin rotary motion of internal combustion engine 12. In order to start internal combustion engine 12 by using spark and fuel, fuel must be instantly available at high pressure to be injected into combustion chambers 43 at or above a predetermined restart pressure because high pressure fuel pump 24 is unable to supply high pressure fuel until rotary motion of internal combustion engine 12 has begun. Accordingly, direct injection engine fuel system 10 is provided with fuel accumulator 56 to provide a supply of high pressure fuel when internal combustion engine 12 is to be started using spark and fuel. Fuel accumulator 56 is placed between and in selective fluid communication with high pressure fuel pump 24 and fuel injectors 42.

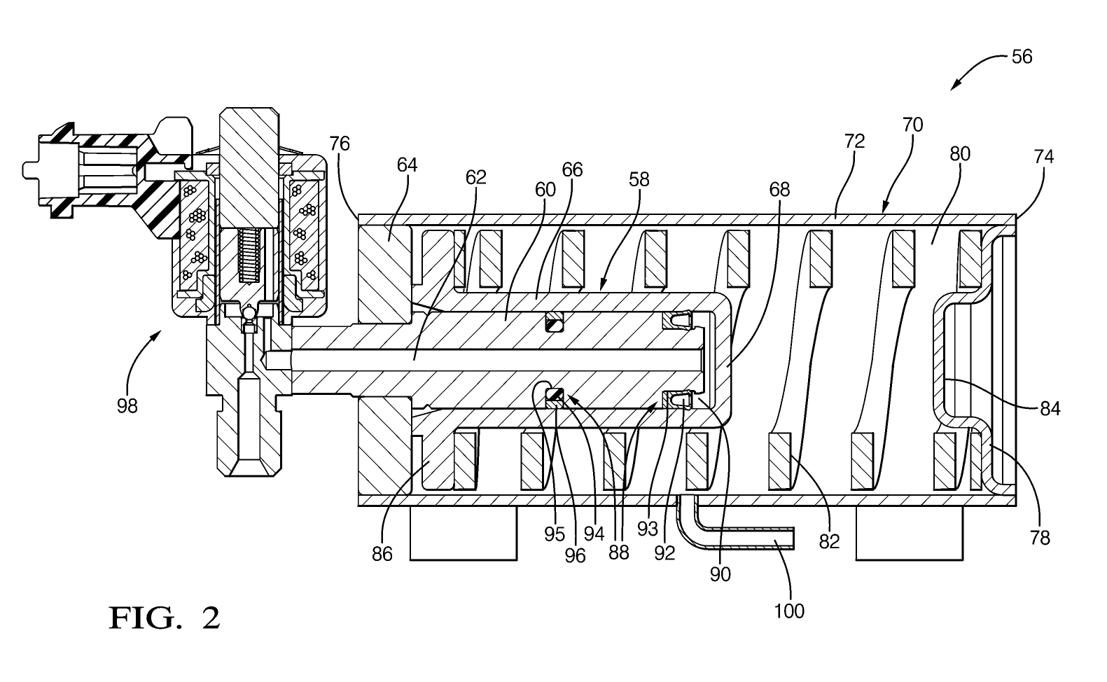

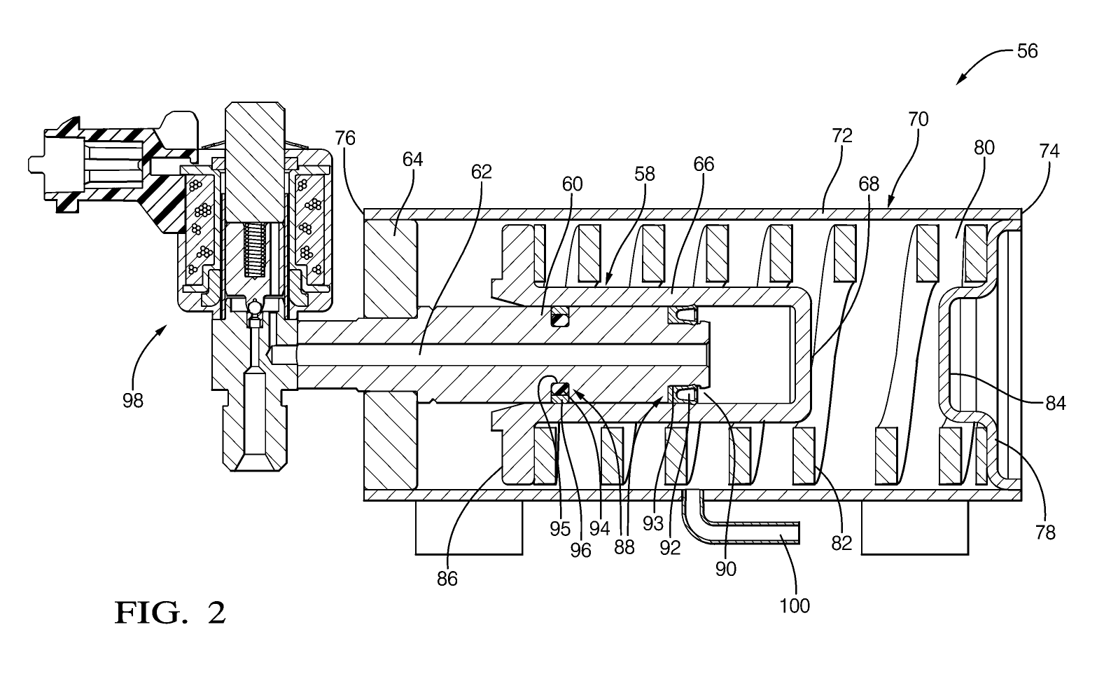

Now referring to FIGS. 2 and 3, fuel accumulator 56 includes plunger assembly 58 having central guide post 60. Central guide post 60 includes fuel passage 62 extending axially therethrough in order to provide fluid communication between opposing ends thereof. Central guide post 60 also includes central guide post flange 64 that extends radially outward from central guide post 60. Central guide post flange 64 may be formed of a separate component that is fixed to central guide post 60 or may alternatively be made of unitary construction with central guide post 60 as a single piece. Plunger assembly 58 also includes plunger 66 which is slidably disposed on central guide post 60. Plunger 66 is cup shaped and includes plunger closed end 68.

Housing 70 includes cylindrical body 72 having closed end 74 and open end 76. Closed end 74 includes closed end cover 78 that is received within cylindrical body 72 and is hermetically sealed therewith in order to prevent fuel vapors from escaping. Closed end cover 78 may be fastened and sealed to cylindrical body 72 by brazing, welding, or other known means. When less stringent evaporative emissions requirements need to be met, closed end cover 78 may be fastened and sealed to cylindrical body 72 by multiple crimps or projection welds. Alternatively, closed end cover 78 may be made of unitary construction with cylindrical body 72 as a single piece in a deep draw process, for example. Open end 76 receives central guide post flange 64 and is hermetically sealed therewith to prevent fuel vapors from escaping. Central guide post flange 64 may be fastened and sealed to cylindrical body 72 by brazing, welding, or other known means. When less stringent evaporative emissions requirements need to be met, central guide post flange 64 may be fastened and sealed to cylindrical body 72 by multiple crimps or projection welds. In this way, housing 70 defines sealed housing chamber 80 there within.

Biasing means 82 is located within sealed housing chamber 80 and is operable to urge plunger 66 toward central guide post 60. Biasing means 82 is preferably a coil compression spring that radially surrounds plunger 66 and central guide post 60. Biasing means 82 may be grounded to housing 70 at closed end cover 78. Closed end cover 78 may include a raised portion 84 that extends axially into sealed housing chamber 80 in order to radially center biasing means 82 within cylindrical body 72. Biasing means 82 may act on plunger 66 through plunger flange 86 that extends radially outward from plunger 66. Plunger flange 86 is preferably located on plunger 66 distally from plunger closed end 68 in order to minimize the size of fuel accumulator 56. Plunger flange 86 may be made of unitary construction as a single piece with plunger 66. Alternatively, plunger flange 86 may be a separate component that is fixed to plunger 66. Biasing means 82 is selected to provide the necessary force to deliver fuel at the predetermined restart pressure which is above 16 MPa in the preferred embodiment, but may be lower or higher depending on requirements of internal combustion engine 12.

Seal means 88 is provided to be operable between plunger 66 and central guide post 60 to create substantially sealed fuel chamber 90 within plunger 66. Seal means 88 may include primary seal 92 disposed proximal to substantially sealed fuel chamber 90 and secondary seal 94 disposed distal to substantially sealed fuel chamber 90. Primary seal 92 is a high pressure seal provided to keep fuel contained within substantially sealed fuel chamber 90. Primary seal 92 may be disposed in primary seal groove 93 that is formed in the outside diameter of central guide post 60. Secondary seal 94 may be a low pressure seal that is provided to contain fuel vapors, isolate fuel films that may coat central guide post 60, help align plunger 66 with central guide post 60, and prevent contact between plunger 66 and central guide post 60. More specifically, secondary seal 94 may be an O-ring or other low cost seal and may include backup ring 96 disposed radially outward from secondary seal 94. Backup ring 96 may be made of PTFE, for example. Secondary seal 94 may be disposed in secondary seal groove 95 that is formed in the outside diameter of central guide post 60.

Fuel admission valve 98 is provided between central guide post 60 and fuel rail 36 in order to selectively prevent and allow fluid communication between fuel rail 36 and fuel passage 62/substantially sealed fuel chamber 90 based on input from fuel system controller 34. Fuel admission valve 98 may be a solenoid actuated control valve or any other control valve capable of preventing and allowing fluid communication between fuel rail 36 and fuel passage 62/substantially sealed fuel chamber 90 based on input from fuel system controller 34. While FIG. 1 shows fuel admission valve 98 being connected to high pressure fuel line 38, it should now be appreciated to one skilled in the art of direct injection fuel systems that fuel admission valve 98 may be included as an integral part of fuel rail 36 and attached thereto accordingly. Such fuel admission valves are well know to those skilled in the art of direct injection engine fuel systems and will not be discussed further herein.

Vapor vent 100 may be provided for allowing fluid communication out of sealed housing chamber 80 to direct injection engine fuel system 10. Vapor vent 100 is preferably connected to purge line 50 in order to allow minute quantities of fuel vapor that may bypass seal means 88 to be captured in evaporative emissions canister 44 and consumed by internal combustion engine 12. In the event of failure of seal means 88, fuel is allowed to enter sealed housing chamber 80 and pass through vapor vent 100. When fuel is allowed to pass through vapor vent 100, the motor vehicle onboard diagnostics (not shown) will detect a rich condition in the engine and cause the malfunction indicator light (not shown) to be set to alert the driver before a dangerous leak occurs. When fuel accumulator 56 is alternatively provided without vapor vent 100, failure of seal means 88 will result in liquid fuel leaking past seal means 88, thereby filling sealed housing chamber 80 until it is pressurized to the same pressure as the liquid fuel being provided by high pressure fuel pump 24 or until fuel accumulator 56 bursts.

In operation and referring to FIG. 2, fuel accumulator 56 is shown in a discharged state. When fuel accumulator 56 is in the discharged state, biasing means 82 urges plunger 66 toward central guide post 60. Plunger 66 may stop when it makes contact with central guide post flange 64. During normal operation of the motor vehicle when internal combustion engine 12 is running, fuel admission valve 98 is closed by command of fuel system controller 34 in order to prevent fluid communication between fuel rail 36 and fuel passage 62/substantially sealed fuel chamber 90.

In operation and referring to FIGS. 1 and 2, when fuel system controller 34 determines that internal combustion engine 12 is ready to be shut down, fuel admission valve 98 is opened by command of fuel system controller 34 in order to allow fluid communication between fuel rail 36 and fuel passage 62/substantially sealed fuel chamber 90. At the same time, fuel system controller 34 commands control valve 32 to allow high pressure fuel pump 24 to generate a fuel pressure supplied to fuel rail 36 at a pressure that is greater than the predetermined restart pressure of the direct injection engine fuel system 10. Since fuel admission valve 98 is open, liquid fuel is supplied to substantially sealed fuel chamber 90 by high pressure fuel pump 24 at a pressure that is greater than the predetermined restart pressure. The fuel pressure supplied to substantially sealed fuel chamber 90 causes plunger 66 to be pushed toward closed end cover 78, thereby compressing biasing means 82. After substantially sealed fuel chamber 90 has received a volume of liquid fuel sufficient for restarting internal combustion engine 12 but before shut down of internal combustion engine 12 is complete, fuel admission valve 98 is closed by command of fuel system controller 34 in order to prevent fluid communication between fuel rail 36 and fuel passage 62/substantially sealed fuel chamber 90. Fuel accumulator 56 is now in the charged state (FIG. 3) and contains a charge of liquid fuel that is sufficient in volume and pressure to restart internal combustion engine 12 when so commanded by fuel system controller 34.

In operation and referring to FIGS. 1-3, when fuel system controller 34 determines that internal combustion engine 12 is ready to be restarted as may be indicated, for example, by accelerator pedal movement or turning the ignition key, fuel admission valve 98 is opened by command of fuel system controller 34 in order to allow fluid communication between fuel rail 36 and fuel passage 62/substantially sealed fuel chamber 90. Since fuel accumulator 56 is in the charged state (FIG. 3), biasing means 82 urges plunger 66 toward central guide post 60 to supply liquid fuel initially above the predetermined restart pressure to fuel rail 36. Fuel is distributed from fuel rail 36 to fuel injectors 42 which are controlled by fuel system controller 34 to supply liquid fuel in the appropriate sequence to combustion chambers 43 where the supplied fuel is ignited in the appropriate sequence by spark plugs 54 to restart internal combustion engine 12. The fuel pressure in fuel rail 36 will drop to the predetermined restart pressure as liquid fuel flows out of fuel injectors 42 into combustion chambers 43. When internal combustion engine 12 begins to make rotary motion, high pressure fuel pump 24 can begin to supply high pressure fuel to fuel rail 36 in order to maintain operation of internal combustion engine 12. Fuel admission valve 98 may now be closed by command of fuel system controller 34 in order to prevent fluid communication between fuel rail 36 and fuel passage 62/substantially sealed fuel chamber 90.

While this invention has been described in terms of the preferred embodiments thereof, it is not intended to be so limited, but rather only to the extent set forth in the claims that follow.

We claim:

1. A fuel accumulator for use in a direct injection engine fuel system having a fuel rail, a predetermined restart pressure, and a fuel system controller that starts and stops said direct injection engine fuel system on command, said fuel accumulator comprising:
a central guide post with a fuel passage therethrough;
a cup shaped, closed ended plunger slidably disposed on said central guide post;
a seal means operable between said plunger and said central guide post to create a substantially sealed fuel chamber within said plunger;
a biasing means operable to urge said plunger onto said central guide post to pressurize said fuel chamber;
and a fuel admission valve located between said central guide post and said fuel rail to selectively provide fluid communication between said fuel passage and said fuel rail in response to said fuel system controller;
whereby when said fuel system controller commands a system stop, said fuel admission valve is opened to admit pressurized fuel through said fuel passage into said fuel chamber, thereby compressing said biasing means until the fuel pressure within said fuel chamber rises to at least said restart pressure, said fuel admission valve is then closed and said biasing means maintains said restart pressure in said fuel chamber;
and whereby when said fuel system controller commands a system start, said fuel admission valve is opened to admit pressurized fuel into said fuel rail from said fuel chamber.

2. A fuel accumulator as in claim 1 further comprising a housing surrounding said plunger and sealed relative to said central guide post to define a sealed housing chamber.

3. A fuel accumulator as in claim 2, wherein said biasing means is a compression spring disposed between said housing and said plunger.

4. A fuel accumulator as in claim 3, wherein said compression spring is disposed between said housing and a flange extending radially outward from said plunger.

5. A fuel accumulator as in claim 1, wherein said seal means includes a primary seal and a secondary seal.

6. A fuel accumulator as in claim 5, wherein said first seal is a high pressure seal.

7. A fuel accumulator as in claim 6, wherein said second seal is a low pressure seal.

8. A fuel accumulator as in claim 2 further comprising a vapor vent for providing fluid communication out of said housing chamber to said fuel system.

9. A fuel rail for use in a direct injection engine fuel system having a predetermined restart pressure and a fuel system controller that starts and stops said direct injection engine fuel system on command, said fuel rail comprising:
a fuel inlet for receiving fuel;
a fuel outlet for dispensing fuel; and
a fuel accumulator, said fuel accumulator comprising:
a central guide post with a fuel passage therethrough;
a cup shaped, closed ended plunger slidably disposed on said central guide post;
a seal means operable between said plunger and said central guide post to create a substantially sealed fuel chamber within said plunger;
a biasing means operable to urge said plunger onto said central guide post to pressurize said fuel chamber;
and a fuel admission valve located between said central guide post and said fuel rail to selectively provide fluid communication between said fuel passage and said fuel rail in response to said fuel system controller;
whereby when said fuel system controller commands a system stop, said fuel admission valve is opened to admit pressurized fuel through said fuel passage into said fuel chamber, thereby compressing said biasing means until the fuel pressure within said fuel chamber rises to at least said restart pressure, said fuel admission valve is then closed and said biasing means maintains said restart pressure in said fuel chamber;
and whereby when said fuel system controller commands a system start, said fuel admission valve is opened to admit pressurized fuel into said fuel rail from said fuel chamber.

10. A fuel rail as in claim 9 further comprising a housing surrounding said plunger and sealed relative to said central guide post to define a sealed housing chamber.

11. A fuel rail as in claim 10, wherein said biasing means is a compression spring disposed between said housing and said plunger.

12. A fuel rail as in claim 11, wherein said compression spring is disposed between said housing and a flange extending radially outward from said plunger.

13. A fuel rail as in claim 9, wherein said seal means includes a primary seal and a secondary seal.

14. A fuel rail as in claim 13, wherein said first seal is a high pressure seal.

15. A fuel rail as in claim 14, wherein said second seal is a low pressure seal.

16. A fuel rail as in claim 10 wherein said fuel accumulator further comprises a vapor vent for providing fluid communication out of said housing chamber to said fuel system.

17. A direct injection engine fuel system having a predetermined restart pressure and a fuel system controller that starts and stops said direct injection engine fuel system on command, said direct injection fuel system comprising:
a fuel tank for storing fuel;
a fuel pump for supplying fuel from said fuel tank to a fuel rail; and
a fuel accumulator, said fuel accumulator comprising:
a central guide post with a fuel passage therethrough;
a cup shaped, closed ended plunger slidably disposed on said central guide post;
a seal means operable between said plunger and said central guide post to create a substantially sealed fuel chamber within said plunger;
a biasing means operable to urge said plunger toward onto said central guide post to pressurize said fuel chamber;
and a fuel admission valve located between said central guide post and said fuel rail to selectively provide fluid communication between said fuel passage and said fuel rail in response to said fuel system controller;
whereby when said fuel system controller commands a system stop, said fuel admission valve is opened to admit pressurized fuel through said fuel passage into said fuel chamber, thereby compressing said biasing means until the fuel pressure within said fuel chamber rises to at least said restart pressure, said fuel admission valve is then closed and said biasing means maintains said restart pressure in said fuel chamber;
and whereby when said fuel system controller commands a system start, said fuel admission valve is opened to admit pressurized fuel into said fuel rail from said fuel chamber.

18. A direct injection engine fuel system as in claim 17 further comprising a housing surrounding said plunger and sealed relative to said central guide post to define a sealed housing chamber.

19. A direct injection engine fuel system as in claim 17 further comprising an evaporative emissions canister for capturing evaporative emissions from said direct injection engine fuel system.

20. A direct injection engine fuel system as in claim 19, wherein said fuel accumulator further comprises a vapor vent for providing fluid communication out of said housing chamber to said evaporative emissions canister.
